(19) United States
(12) Patent Application Publication
(10) Pub. No.: US 2010/0290388 A1
(43) Pub. Date: Nov. 18, 2010

(54) INTEGRATED INTERNET MULTIMEDIA AND COMPUTING ACCESS INTERACTIVE COMMUNICATION DEVICE

(76) Inventor: Siddhartha Srivastava, Mumbai (IN)

Correspondence Address: ARENT FOX LLP, 1050 CONNECTICUT AVENUE, N.W., SUITE 400, WASHINGTON, DC, 20036, US

(21) Appl. No.: 12/092,374

(22) PCT Filed: Apr. 11, 2008
(86) PCT No.: PCT/IB2008/000874

§ 371 Date: Aug. 3, 2010

(30) Foreign Application Priority Data
Jul. 2, 2007 (IN) 1254/MUM/2007

(51) Int. Cl. H04W 40/00

(52) U.S. Cl. 370/328

(57) ABSTRACT

A communication device for integrated interactive multimedia and access to remote computing power and data storage capabilities. The communication device is present in a network and converts the signals received from the network into audio, video or web content. Further, the communication device is capable of accessing remote computing power and data storage capabilities from servers through the network.

### BACKGROUND OF THE INVENTION

1. Field of the Invention

The present invention relates to communication devices in general. More specifically, the present invention relates to communication devices providing integrated interactive multimedia Internet Protocol Television (IPTV) and large-scale computing access through a network infrastructure.

2. Description of the Prior Art

These days, the delivery of television over the Internet is becoming widespread. The distribution of television programming using the traditional methods such as broadcasting by radio, satellite or cable to the public or the homes of subscribers are giving way to the new methods which use network infrastructure such as Internet to deliver audio-video content at the user's selection and demand for display by television.

Presently, IPTV has started to diffuse widely, as an increasingly popular means for distributing digital television programming. IPTV typically is supplied by the broadband operators using a closed network infrastructure. IPTV may be used to deliver television content over Local Area Networks (LAN) and business networks or even over public networks such as the Internet. IPTV usually requires either a Personal computer (PC) or a Set-Top box connected to a television. The Set-top box is connected to an external signal source and converts the signals received from the network into audio, video or web content. One drawback associated with the present IPTV is that there is a lack of integration with large scale computing devices or remote computing power. This results in availability of a limited computing power.

Further, the present IPTV's setup comprising a Set-top box connected to a television is usually large and hence difficult to carry or transport.

Moreover, portable, Internet-enabled multimedia communication devices such as iPhone® are becoming increasingly available. The iPhone® offers Internet services as well as multimedia streaming in addition to the communication functionality. The limitation associated with the iPhone® is that iPhone® offers only limited amounts of data storage. Further, the iPhone® does not have access to substantially large amount to computing power. Additionally, the iPhone® does not support a distributed computing network.

In the light of the foregoing, there is a need for a communication device which offers integrated interactive multimedia as well as access to substantially large amount of computing power. Further, the device should be portable and hence easy to carry or transport. Moreover, the device should work in a grid computing network allowing the device to optimally utilise the available aggregated computing power.

### SUMMARY OF THE INVENTION

Accordingly, it is an object of the present invention to provide a communication device providing interactive multimedia and access to substantially large computing power.

It is another object of the present invention to provide a communication device having access to remote operating centres possessing substantially large data storage capabilities.

The above and other objects of the present invention are achieved by providing a communication device for providing interactive multimedia and access to substantially large computing power.

In accordance with an embodiment of the present invention, the communication device includes a converter and a thin client. The converter and the thin client are connected to each other. One or more networks provide one or more signals to the communication device. The thin client receives and processes the one or more signals. The processed signals are sent to the converter. The converter converts the processed one or more signals into at least one of an audio, a video or a web content. A display unit is connected to the communication device for displaying the video or the web content. Further, the thin client provides access to one or more remote network operating centres. The one or more remote network operating centres possess substantially large data storage capabilities and computing power. The one or more remote network operating centres and the communication device are connected to each other through the one or more networks.

The present invention provides a communication device which provides integrated interactive multimedia and secure access to substantially large computing power. Further, the present invention provides substantially large data storage capabilities. Moreover, the communication device of the present invention is compact, portable, and easy to use and transport. Additionally, the communication device is capable of presenting audio, video or web content through the Internet or intranet.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 illustrates an environment in which various embodiments of the present invention may be practised.

FIG. 2 shows a communication device in accordance with one of the embodiments of the present invention.

FIG. 3 shows the communication device in accordance with another embodiment of the present invention.

FIG. 4 illustrates the architecture of a communication device in accordance with an embodiment of the present invention.

FIG. 5 illustrates a block diagram of the various components of the communication device in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular system for integrated interactive multimedia and access to substantially large scale computing power in accordance with an embodiment of the present invention, it should be observed that the present invention resides primarily in combinations of system components related to communication device of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The present invention illustrates a communication device. Specifically, the present invention aims at providing a communication device which provides integrated interactive multimedia and secure access to substantially large scale computing power and data storage capabilities.

The communication device of the present invention includes a thin client and a converter. The communication device is capable of receiving one or more signals from one or more networks. The thin client processes one or more signals and sends the processed signals to the converter. The converter converts the processed one or more signals into at least one of an audio, a video or a web content. Further, the thin client is capable of accessing substantially large computing power from one or more remote network operating centres. The one or more network remote network operating centres include one or more servers. The communication device, the one or more remote network operating centres, the one or more servers are connected to each other through the one or more networks. Further, the one or more remote operating centres provide the communication device with access to substantially large hosted data storage capabilities through interfacing with the thin client. Moreover, the communication device is capable of playing an audio, a video or displaying a file or web content stored in the one or more servers.

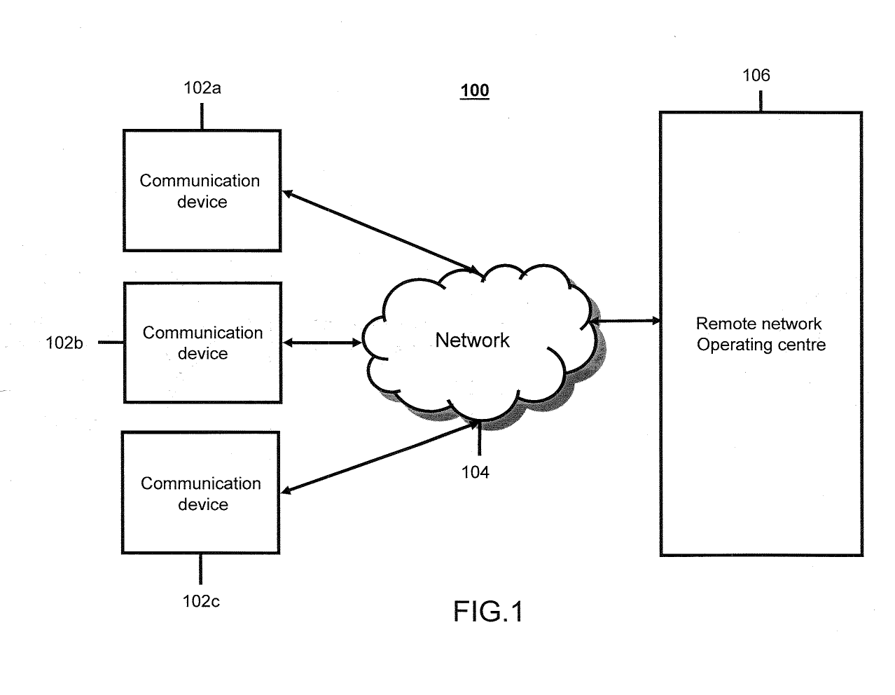

FIG. 1 illustrates an environment 100 in which various embodiments of the present invention may be practised. The environment 100 includes a communication device 102a, 102b, and 102c, hereinafter referred collectively as a communication device 102, a network 104 and a remote network operating centre 106.

Examples of the communication device 102 include, but are not limited to, a mobile phone, a Personal Digital Assistant (PDA), a landline phone, a notebook computer, a webcam, a microphone and a pager. The remote network operating center 106 includes one or more servers possessing substantially large computing power and data storage. The communication device 102 is connected to the remote network operating centre 106 through the network 104. Examples of the communication media for network 104 include, but are not limited to, at least one of Internet, intranet, Wifi, Bluetooth, Infrared, WiMAX, Local Area Network (LAN), GPRS, EDGE, E-VDO, WCDMA and Virtual Private network (VPN).

According to one of the embodiments of the present invention, the network 104 is a conglomeration of connected intranets.

According to another embodiment of the present invention, the network 104 is the IPV6-compatible Internet.

The communication device 102 and the remote network operating centre 106 can be connected to each other through one or more of cables, switched telephone connection, fiberoptic links, and wireless connection. The communication device 102 receives one or more signals from network 104. The one or more signals are converted into at least one of an audio, a video and web content. The communication device 102 is capable of accessing the network operating centre 106 through the network 104. Examples of the one or more servers include, but are not limited to, at least one of a supercomputer, an application server and a personal computer. The one or more servers can be a part of at least one of a grid computing network, a cloud computing network, and a distributed computing network. For example, in a grid-computing network environment, the one or more servers can be distributed over a particular region, a country, or all over the world. Thus, a user of the communication device 102 can connect to a server of the one or more servers, which is closest to the communication device 102. This results in a better connectivity, speed and bandwidth available to the user.

According to one of the embodiments of the present invention, the one or more servers are equipped with one or more security levels. Examples of the one or more security levels include, but are not limited to, authentication (for example by token, password or biometric), data encryption using https protocol or VPN or the like, one or more firewalls at the client or the server, twin key encryption, and a military grade encryption.

According to another embodiment of the present invention, the communication device 102 is capable of playing an audio, a video or displaying a data file stored in the remote network operating centres 106. Further, a user can operate on the data file stored in the one or more servers of remote network operating centres 106. By way of example, only, the data file stored at operating centre 106 can comprise any sort of information upon which a user might otherwise operate at a personal computer, including without limitation any one of a word processing document, spreadsheet, graphics or animation file, video or audio editing or recording file, photography, or personal information manager.

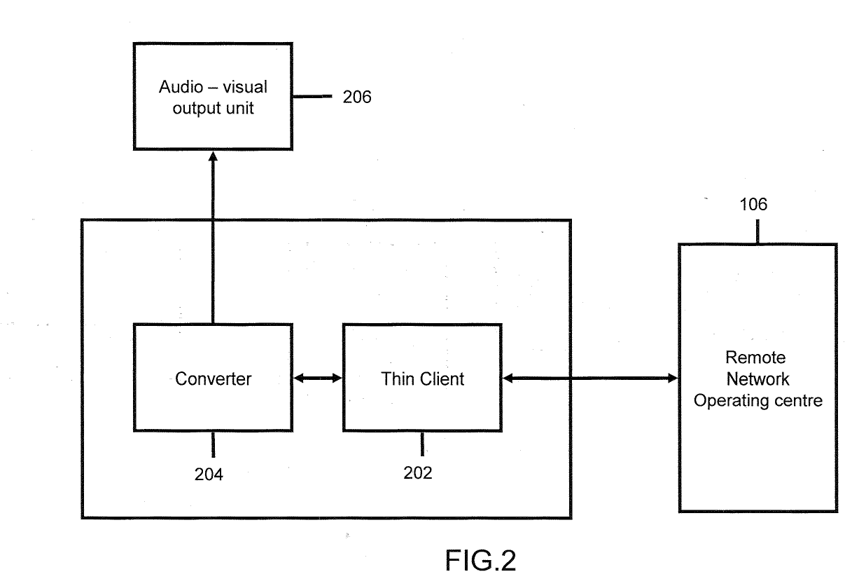

FIG. 2 shows the communication device 102 in accordance with one of the embodiments of the present invention. The communication device 102 includes a thin client 202 and a converter 204. The figure also shows the remote network operating centre 106 and a display unit 206. The thin client 202 is a client computer or client software in client-server architecture networks which depends primarily on a remote server for processing activities and focuses on conveying input and output between a user and the remote server. The thin client 202 is capable of processing the one or more signals, where the one or more signals are received from one or more networks. In the present embodiment, the thin client 202 receives the one or more signals from the network 104 and processes the received one or more signals. The thin client 202 is further capable of being connected to one or more remote network operating centers through the one or more networks, where each of the one or more remote network operating centers includes one or more servers. In the present embodiment, the thin client 202 is connected to the remote network operating centres 106.

The converter 204 is connected to the thin client 202, and is capable of converting at least one processed signal of the one or more processed signals into at least one of an audio, a video and web content. In the present embodiment, the converter 204 converts at least one signal processed by the thin client 202 into at least one of an audio, a video and web content. Examples of the converter 204 include, but are not limited to, a Set-top box. Further, the thin client 202 provides access to substantially large scale computing power and data storage capabilities of the remote network operating centre 106.

The communication device 102 is connected to the audio-visual output unit 206. The audio-visual output unit 206 displays the video or the web content. Examples of the audio-visual output unit 206 include, but are not limited to, a television, a monitor, a High Definition television (HDTV), and a visual display unit.

According to one of the embodiments of the present invention, the communication device 102 includes one or more hardware ports. Each of the one or more hardware ports is either a serial port or a parallel port. Examples of the one or more hardware ports include, but are not limited to, USB port, Ethernet port, PCMCIA port, flash memory card reader, HDMI, composite video, RCA (for analog audio or video), VGA serial port, FireWire port and S-video port.

According to another embodiment of the present invention the converter 204 receives the one or more signals directly from the network 104 and converts them into at least one of the audio, the video or the web content.

According to still another embodiment of the present invention, the communication device 102 is capable of playing an audio, a video or displaying a data file stored in the one or more servers. Further, a user can operate on the data file stored in the one or more servers.

According to yet another embodiment of the present invention, the communication device 102 is present in at least one of a grid computing network, a cloud computing network and a distributed computing network wherein the communication device 102 is present in the one or more networks and connected to a plurality of network operating centres 106. In the present embodiment, the communication device 102 is capable of accessing remote computing power and data storage capabilities from the one or more remote network operating centres 106 based on existing load of applications running on the one or more servers. This arrangement will result in optimal utilisation of computing power and data storage capabilities of the one or more network operating centres 106. The communication device 102 is capable of connecting with the one or more remote network operating centres 106 through at least one of the one of the one or more networks.

According to another embodiment of the present invention, the communication device 102 has a unique IP address or supports so-called “personal URL” (PURL) as is currently being proposed in the digital media industry, and supports at least one of a Global Service for Mobile Communication (GSM), Code Division Multiple Access (CDMA), 3rd Generation (3G), 4th Generation (4G) technology. The unique IP address can be allocated to the communication device 102 through Internet Protocol version 6 (IPv6).

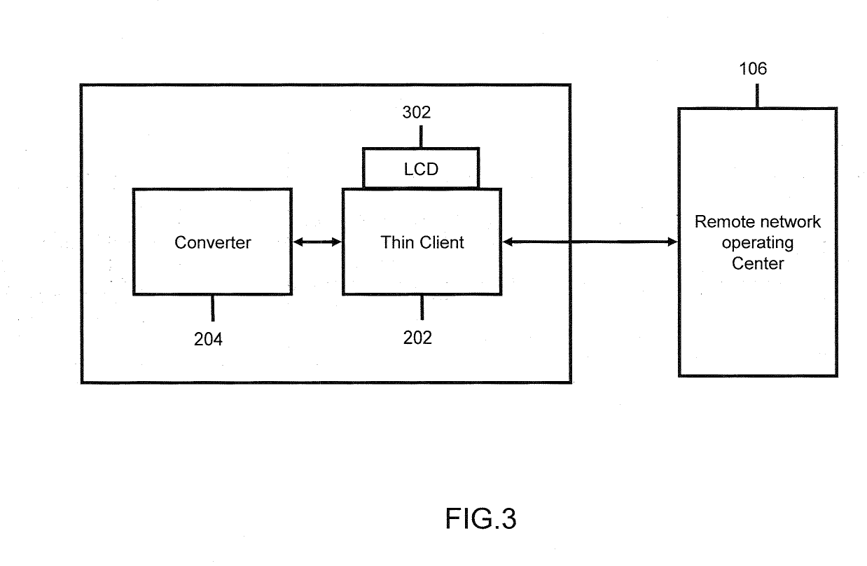

FIG. 3 shows the communication device 102 in accordance with another embodiment of the present invention. Communication device 102 includes the thin client 202, the converter 204 and a display unit 302. The one or more signals received by the thin client 202 are converted into the processed one or more signals. The converter 204 converts the processed one or more signals into at least one of an audio, a video and web content. The video or the web content is displayed on the display unit 302. Examples of audio-visual display unit include and are not limited to Liquid Crystal Display (LCD) screen, Organic Light Emitting Diode (OLED) and the like.

In accordance with an embodiment of the invention, the LCD screen is a touch screen. Further, the touch screen is operated through at least one of a stylus or human touch.

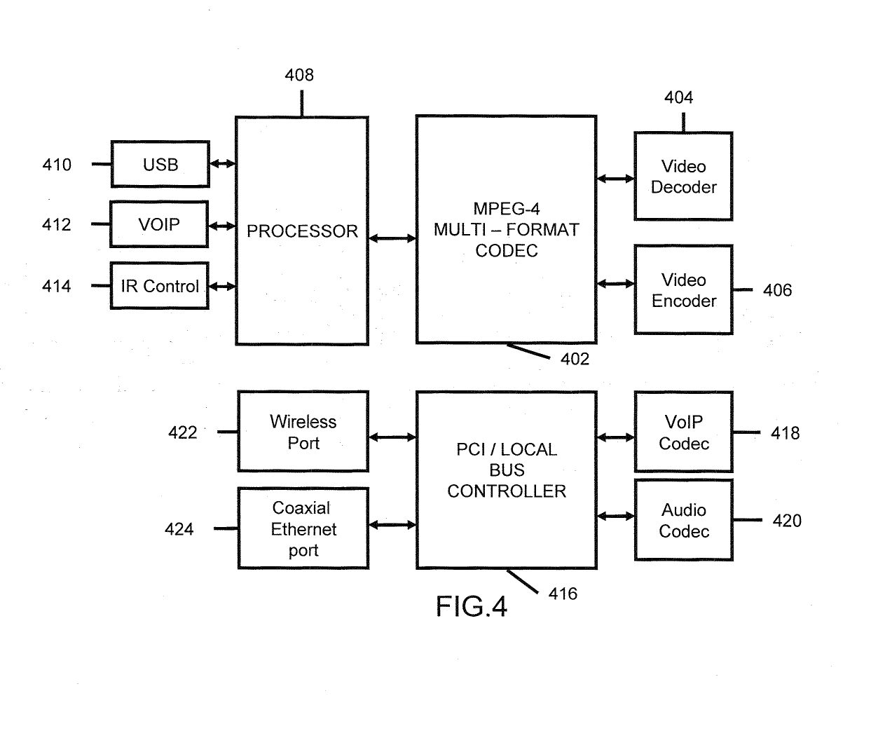

FIG. 4 illustrates the architecture of the communication device 102 in accordance with an embodiment of the present invention. The communication device 102 includes an MPEG-4 type multi format codec 402 such as MPEG-4, Quicktime, DivX, H.264 or the like, a video decoder 404, a video encoder 406, a processor 408, a Universal Serial Bus (USB) port 410, a VoIP telephony port 412, an Infra red (IR) control port 414, a Peripheral Component Interconnect (PCI) Bus controller 416, a VoIP codec 418, an audio codec 420, a wireless port 422 and a coaxial cable Ethernet port 424. The MPEG-4 multi format codec 402 is connected to the video encoder 404, the video decoder 406 and the processor 408. The processor 408 is connected to one or more ports. Examples of the one or more ports include and are not limited to the USB port 410, the VoIP telephony port 412 and the IR control port 414. The functionality of the one or more ports is the same as ports of other conventional electronics devices. The PCI Bus controller interface 416 is connected to the VoIP codec 418 and the Audio codec 420. Further, the communication device 102 includes at least one of a wireless port 422 (respectively compatible with IEEE 802.11 and IEEE 802.16 wireless networking protocols) and coaxial Ethernet port connected to a PCI Bus controller 424.

According to one of the embodiments of the present invention, the communication device 102 includes a mobile synchronous dynamic random access memory (RAM) and a sensor module such as a CMOS or a CCD unit.

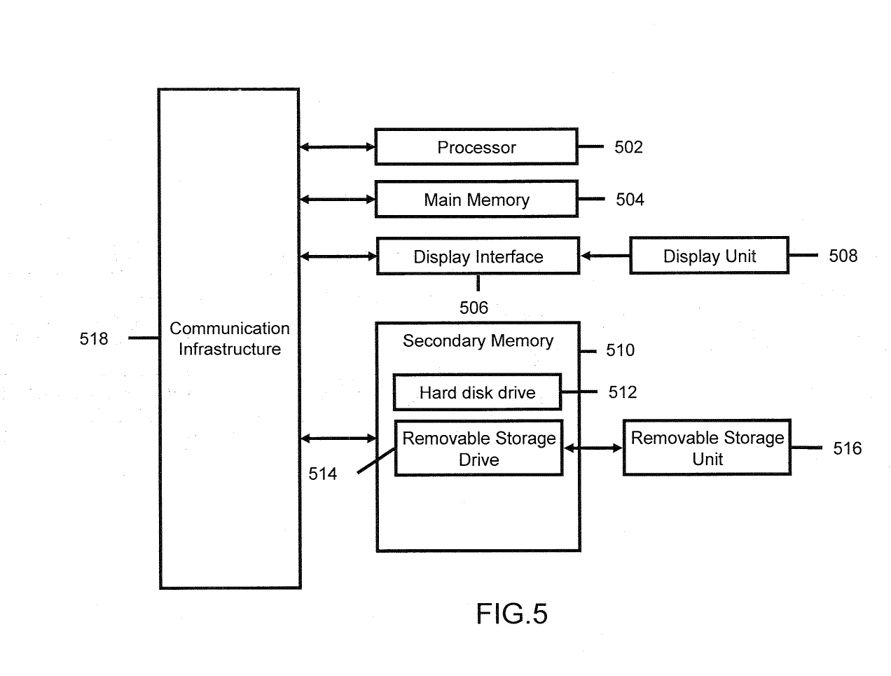

FIG. 5 illustrates a block diagram of the various components of the communication device 102 in accordance with an embodiment of the present invention. The communication device 102 includes a processor 502, a main memory 504, a display interface 506, a display unit 508, a secondary memory 510, a hard disk drive 512 and a removable storage drive 514. The figure further shows a communication infrastructure 516 and a removable storage unit 518. The processor 502 and the main memory 504 are connected to the communication infrastructure 516. Examples of main memory 504 include, but are not limited to, random access memory (RAM). The display interface 506 forwards data from the communication infrastructure 516 for display on the display unit 508. Further, the secondary memory 510 is also connected to the communication infrastructure 516 and includes the hard disk drive 512 and the removable storage device 514. Examples of the removable storage device 516 include, but are not limited to, a floppy disk drive, a magnetic tape drive, and an optical disc drive. Removable storage drive 514 reads or writes from removable storage unit 518. Examples of the removable storage unit 518 include, but are not limited to, a floppy disk, a magnetic tape, and an optical disk. As will be appreciated, the removable storage unit 522 includes a computer usable storage medium having stored therein at least one of a computer software and data.

According to one of the embodiments of the present invention, the secondary memory 510 includes an interface and a corresponding removable storage unit. For example, the communication device 102 includes a program cartridge and a cartridge interface, a removable memory chip such as an erasable programmable read only memory (EPROM) or a programmable read only memory.

According to another embodiment of the present invention, the communication device 102 includes a communication interface. The communication interface allows software and data to be transferred between the communication device 102 and external devices. Examples of the communication interface include, but are not limited to, a modem, a network interface such as an Ethernet card, a communication port, and a Personal Computer Memory Card International Association (PCMCIA) slot, and card. The software and data transferred through the communication interface are in the form of the one or more signals. Examples of the one or more signals include, but are mot limited to, electronic, electromagnetic, optical or other signals capable of being received by the communication interface. The one or more signals are provided to the communication interface through a communications path. The communication path carries the one or more signals and are implemented using either one of wire or cable, fiber optics, a telephone line, a cellular link, a RF or IR link and/or other communications channels.

In this document, the terms “computer program medium” and “computer usable medium” are used to refer generally to media such as the removable storage drive 514, a hard disk installed in the hard disk drive 512, and the one or more signals. The computer program products provide software to the communication device 102.

One or more computer programs (also referred to as computer control logic) are stored in the main memory 504 and/or the secondary memory 510. The one or more computer programs may also be received through the communications interface. The one or more computer programs, when executed, enable the communication device 102 to perform the features of the present invention, as discussed herein. In particular, the one or more computer programs, when executed, enable the processor 504 to perform the features of the present invention. Accordingly, the one or more computer programs represent controllers of the communication device 102.

According to an embodiment of the present invention, the present invention is implemented using one or more computer programs or software, the one or more computer programs or software are stored in a computer program product and loaded into the communication device 102 using the removable storage drive 514, the hard drive 512, or the communication interface 518. The control logic (software), when executed by the processor 504, causes the processor 504 to perform the functions of the invention as described herein.

According to another embodiment of the present invention, the present invention is implemented primarily in hardware using hardware components such as application specific integrated circuits (ASICs). Implementation of the hardware state machine so as to perform the functions described herein will be apparent to persons skilled in the relevant art(s).

The communication device 102 may be implemented using Integrated Circuits (ICs) and may be reduced in size to represent a compact, portable, easily transportable device that securely integrates IPTV and multimedia access, personal computer capabilities, cellular telephony functions, Internet access, and large-scale computing access. In one embodiment, the communication device 102 may also include Global Positioning System (GPS) capabilities.

The communication device of the present invention provides integrated interactive media and secure access to remote computing power and data storage capabilities. Further, the present invention provides substantially large data storage capabilities. Moreover, the communication device of the present invention is compact, portable, and easy to use and transport. Additionally, the communication device is capable of presenting audio, video or web content through the Internet or intranet.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A communication system comprising one or more data transmission networks for providing interactive multimedia and computing access, the system comprising:
a remote network operating center comprising one or more servers and having computing power and data storage capabilities, the remote network operating center being connected to the one or more data transmission networks;
a thin client that processes data transmitted via the one or more data transmission networks and provides access to at least one of the one or more remote network operating centers;
a converter connected to the thin client, the converter converting the processed data into at least one selected from a group consisting of audio, video and web content.

2. The communication system according to claim 1, the thin client and the converter comprising a communication device, the communication device further comprising:
one or more hardware ports.

3. The communication device according to claim 2, wherein each port of the one or more hardware ports is one of a serial and a parallel port.

4. The communication system according to claim 1, wherein the one or more data transmission networks is one selected from a group consisting of a Wi-Fi network, a Bluetooth network, an Infrared network, a WiMAX network, a Local Area Network (LAN) network, a GPRS network, an EDGE network and a Virtual Private network (VPN).

5. The communication system according to claim 1, wherein the converter is a set-top unit.

6. The communication system according to claim 1, wherein the thin client has a display unit.

7. The communication system according to claim 6, wherein the display unit is a LCD screen.

8. The communication system according to claim 7, wherein the LCD screen is a touch screen.

9. The communication system according to claim 1, wherein the one or more servers is one selected from a group consisting of a supercomputer, an application server and a personal computer.

10. The communication system according to claim 1, wherein the remote network operating centers is one selected from a group consisting of a grid computing network, a cloud computing network, and a distributed computing network.

11. The communication system according to claim 1, wherein the one or more severs is equipped with one or more security levels.

12. The communication system according to claim 11, wherein the one or more security levels one selected from a group consisting of military grade encryption and one or more firewalls.

13. The communication system according to claim 1 further comprising:
a primary memory.

14. The communication system according to claim 13, wherein the primary memory is a Random Access Memory (RAM).

15. The communication system according to claim 1 further comprising:
a secondary memory.

16. The communication system according to claim 15, wherein the secondary memory is one selected from a group consisting of a hard disk drive and a removable storage unit.

17. The communication system according to claim 16, wherein the removable storage unit is one selected from a group consisting of a floppy disk, a flash memory, a magnetic tape and an optical disc.

18. The communication system according to claim 2 further comprising:
a communication interface, the communication interface transferring data between the communication device and the one or more servers.

19. The communication system according to claim 18, wherein the communication interface is selected from a group consisting of a modem, an Ethernet card, a PCMCIA port, a WiFi port, WIMAX functionality and a communication port.

20. The communication system according to claim 2, wherein a connection between the communication device and the one or more servers is established using one selected from a group consisting of a switched telephone connection, a cable connection and a wireless connection.

21. The communication device according to claim 2, wherein the communication device has a unique IP address.

22. The communication device according to claim 2, wherein the communication device supports one selected from a group consisting of CDMA technology, GSM technology, 3G technology and 4G technology.

23. A communication device for providing interactive multimedia and computing access through one or more remote network operating centers, each of the one or more remote network operating centers comprising one or more servers, the one or more remote network operating centers being coupled via one or more networks, the one or more networks providing one or more data transmissions, the communication device comprising:
a thin client that processes the one or more data transmissions and provides access to at least one of the one or more remote network operating centers, the one or more remote network operating centers having substantially large computing power and data storage capabilities;
a converter connected to the thin client that converts at least one processed data transmission of the one or more processed data transmissions into at least one selected from a group consisting of audio, video and web content; and
a display unit connected to the thin client, the display unit displaying the at least one selected from a group consisting of audio, video and web content.

24. A method for providing interactive multimedia and computing access for one or more data transmission networks via a remote network operating center comprising one or more servers and having computing power and data storage capabilities, the method comprising:
processing, via a thin client, data transmitted via the one or more data transmission networks;
providing access to at least one of the one or more remote network operating centers; and
converting, via a converter coupled to the thin client, the processed data into at least one selected from a group consisting of audio, video and web content.

25. The method of claim 24, wherein the thin client and the converter comprise a communication device, the communication device further including one or more hardware ports.

26. The method of claim 25, further comprising:
transferring, via a communication interface, data between the communication device and the one or more servers.

27. The method of claim 26, wherein the communication interface is selected from a group consisting of a modem, an Ethernet card, a PCMCIA port, a WiFi port, WIMAX functionality and a communication port.

28. The method of claim 25, further comprising:
establishing a connection between the communication device and the one or more servers via one selected from a group consisting of a switched telephone connection, a cable connection and a wireless connection.

29. The method of claim 25, wherein the communication device has a unique IP address.

30. The method of claim 25, further comprising:
supporting, via the communication device, one selected from a group consisting of CDMA technology, GSM technology, 3G technology and 4G technology.

31. The method of claim 25, wherein each port of the one or more hardware ports is one of a serial and a parallel port.

32. The method of claim 24, wherein the one or more data transmission networks is one selected from a group consisting of a Wi-Fi network, a Bluetooth network, an Infrared network, a WiMAX network, a Local Area Network (LAN) network, a GPRS network, an EDGE network and a Virtual Private network (VPN).

33. The method of claim 24, wherein the converter is a set-top unit.

34. The method of claim 24, wherein the thin client has a display unit.

35. The method of claim 34, wherein the display unit is a LCD screen.

36. The method of claim 35, wherein the LCD screen is a touch screen.

37. The method of claim 24, wherein the one or more servers is one selected from a group consisting of a supercomputer, an application server and a personal computer.

38. The method of claim 24, wherein the remote network operating centers is one selected from a group consisting of a grid computing network, a cloud computing network, and a distributed computing network.

39. The method of claim 24, wherein the one or more severs is equipped with one or more security levels.

40. The method of claim 39, wherein the one or more security levels one selected from a group consisting of military grade encryption and one or more firewalls.

41. A method for providing interactive multimedia and computing access via one or more remote network operating centers, each of the one or more remote network operating centers including one or more servers, the one or more remote network operating centers being coupled via one or more networks, the one or more networks providing one or more data transmissions, the method comprising:
processing, via a thin client, the one or more data transmissions;
providing access to at least one of the one or more remote network operating centers, the one or more remote network operating centers having substantially large computing power and data storage capabilities;
converting, via a converter connected to the thin client, at least one processed data transmission of the one or more processed data transmissions into at least one selected from a group consisting of audio, video and web content; and
displaying, via a display unit coupled to the thin client, the at least one selected from a group consisting of audio, video and web content.

42. A system for providing interactive multimedia and computing access for one or more data transmission networks via a remote network operating center comprising one or more servers and having computing power and data storage capabilities, the system comprising:
means for processing, via a thin client, data transmitted via the one or more data transmission networks;
means for providing access to at least one of the one or more remote network operating centers; and
means for converting, via a converter coupled to the thin client, the processed data into at least one selected from a group consisting of audio, video and web content.

43. A system for providing interactive multimedia and computing access via one or more remote network operating centers, each of the one or more remote network operating centers including one or more servers, the one or more remote network operating centers being coupled via one or more networks, the one or more networks providing one or more data transmissions, the system comprising:
means for processing, via a thin client, the one or more data transmissions;
means for providing access to at least one of the one or more remote network operating centers, the one or more remote network operating centers having substantially large computing power and data storage capabilities;
means for converting, via a converter connected to the thin client, at least one processed data transmission of the one or more processed data transmissions into at least one selected from a group consisting of audio, video and web content; and
means for displaying, via a display unit coupled to the thin client, the at least one selected from a group consisting of audio, video and web content.

44. A computer program product for use with a computer, the computer program product comprising a computer usable medium having a computer readable program code stored thereon for providing interactive multimedia and computing access for one or more data transmission networks via a remote network operating center comprising one or more servers and having computing power and data storage capabilities, the computer program product performing the steps of:
processing, via a thin client, data transmitted via the one or more data transmission networks;
providing access to at least one of the one or more remote network operating centers; and
converting, via a converter coupled to the thin client, the processed data into at least one selected from a group consisting of audio, video and web content.

45. A computer program product for use with a computer, the computer program product comprising a computer usable medium having a computer readable program code stored thereon for providing interactive multimedia and computing access via one or more remote network operating centers, each of the one or more remote network operating centers including one or more servers, the one or more remote network operating centers being coupled via one or more networks, the one or more networks providing one or more data transmissions, the computer program product performing the steps of:
processing, via a thin client, the one or more data transmissions;
providing access to at least one of the one or more remote network operating centers, the one or more remote network operating centers having substantially large computing power and data storage capabilities;
converting, via a converter connected to the thin client, at least one processed data transmission of the one or more processed data transmissions into at least one selected from a group consisting of audio, video and web content; and
displaying, via a display unit coupled to the thin client, the at least one selected from a group consisting of audio, video and web content.
